(19) United States
(12) Patent Application Publication
(10) Pub. No.: US 2013/0177668 A1
(43) Pub. Date: Jul. 11, 2013

(54) SOLIDIFIED SUGAR ALCOHOL MIXTURE

(71) Applicants: Roland Fuchs, Krefeld (DE); Michel Henri Andre Gonze, Brussels (BE); Bernhard Johannes Lüssem, Krefeld (DE); Christof Küsters, Krefeld (DE); Volker Potthoff, Krefeld (DE); Amo Uklei, Uedem (DE); Heinz Josef Ulrich, Krefeld (DE)

(72) Inventors: Roland Fuchs, Krefeld (DE); Michel Henri Andre Gonze, Brussels (BE); Bernhard Johannes Lüssem, Krefeld (DE); Christof Küsters, Krefeld (DE); Volker Potthoff, Krefeld (DE); Amo Uklei, Uedem (DE); Heinz Josef Ulrich, Krefeld (DE)

(73) Assignee: CARGILL ,INCORPORATED, Wayzata, MN (US)

(21) Appl. No.: 13/820,942

(22) PCT Filed: Sep. 1, 2011
(86) PCT No.: PCT/EP2011/004421

§ 371 Date: Mar. 5, 2013

(30) Foreign Application Priority Data
Sep. 7, 2010 (EP) 10009270.9

(51) Int. Cl. A23G 3/38; A23G 4/06

(52) U.S. Cl. CPC A23G 3/38; A23G 4/06
USPC 426/3; 426/548; 426/443

(57) ABSTRACT

The present invention relates to solidified sugar alcohol mixture containing maltitol characterized in that the mixture is comprising more than 70% w/w maltitol and less than 95% w/w maltitol based on dry matter of mixture and it is comprising from 2-10% w/w mannitol based on dry matter of the mixture and upon tabletting said mixture, a hardness of from 70 N to 220 N is obtained at a compression force of 5 kN to 25 kN. It further describes the process for preparing solidified sugar alcohol mixtures and the chewing gum and tablets containing the solidified sugar alcohol mixture of the present invention.

### FIELD OF THE INVENTION

The present invention relates to solidified sugar alcohol mixtures containing more than 70% w/w and less than 95% w/w maltitol and a process for preparing these and the corresponding chewing gum composition and tablets containing the solidified sugar alcohol mixtures.

### BACKGROUND OF THE INVENTION

Sugar alcohol and sugar alcohol mixtures are used to a great extent as additives and carriers, inter alia, for tablets for chewing and sucking, chewing gum and other products of the confectionery industry. Sugar alcohols are generally produced by hydrogenation of their underlying carbohydrates.

Maltitol itself, is a sugar alcohol obtained through catalytic hydrogenation of maltose. Crystalline maltitol and crystalline mixture solid containing it are widely used in food, pharmaceuticals, and cosmetics due to their low hygroscopicity and excellent performance as an excipient.

EP 0 816 373 describes a process for manufacturing crystalline maltitol and crystalline mixture solid containing this and more particularly to a process for manufacturing in any desired ratio both crystalline maltitol and crystalline mixture solid containing this.

U.S. Pat. No. 6,165,511 describes a polyol composition useful for the production of tablets and which is obtained by co-spray drying or co-fluidized bed granulating at least two polyols, one of which is non-hygroscopic polyol and the non-hygroscopic polyol is present in an amount of at least 80% by weight.

U.S. Pat. No. 5,651,829 relates to a crystalline maltitol composition which essentially exhibits a porous and honeycombed structure and which possesses a very high degree of maltitol purity and a low density.

EP 1 738 657 describes a powdery sugar alcohol composition for tabletting. The composition consists essentially of a crystalline sugar alcohol and an amorphous sugar alcohol provided that the composition comprises 2-12% of amorphous sorbitol.

WO 2005037849 relates to a process for preparing solidified maltitol. The solidified maltitol is prepared by turbulating a maltitol powder with gas and contacting it with a maltitol containing syrup wherein the quantity of the powder is a the quantity of the syrup. The solidified maltitol has superior properties in bakery products. It is further suitable in other food products such as confectionery, chewing gum coatings and tablets.

There is still a further need of having a solidified sugar alcohol mixture mainly for use in chewing gum composition and tablets. The current invention provides such a product.

### SUMMARY OF THE INVENTION

The current invention relates to a solidified sugar alcohol mixture containing maltitol characterized in that the mixture is comprising less than 95% w/w maltitol based on dry matter of mixture and upon tabletting a fraction of said mixture having an average particle size of from 150 to 250 microns, a hardness of from 70 to 220 N is obtained at a compression force of 5 kN to 25 kN and said solidified sugar alcohol mixture is containing more than 70% w/w maltitol based on dry matter of mixture and it is comprising from 2-10% w/w mannitol based on dry matter of the mixture, preferably from 3 to 6% w/w mannitol.

The current invention further relates to a process for preparing a solidified sugar alcohol mixture previously described and said process is comprising the following steps:
a) Bringing a mixture of sugar alcohols to a moisture content of below 5%,
b) Kneading the sugar alcohol mixture through an extruder,
c) Aging the extruded solidified sugar alcohol mixture.

Furthermore, the current invention relates to chewing gum composition containing a gum base, a flavouring agent and sweetening filler comprising the previously described solidified mixture of sugar alcohols.

Finally, the current invention relates to a tablet comprising the previously described solidified mixture of sugar alcohols.

### DETAILED DESCRIPTION

The current invention relates to a solidified sugar alcohol mixture containing maltitol characterized in that the mixture is comprising less than 95% w/w maltitol based on dry matter of mixture and upon tabletting a fraction of said mixture having an average particle size of from 150 to 250 microns, a hardness of from 70 to 220 N is obtained at a compression force of 5 kN to 25 kN and said solidified sugar alcohol mixture is containing more than 70% w/w maltitol based on dry matter of mixture and it is comprising from 2-10% w/w mannitol based on dry matter of the mixture, preferably from 3 to 6% w/w mannitol.

Sugar alcohol, also known as polyol, polyhydric alcohol or polyol, is a hydrogenated (reduced) form of carbohydrates wherein the carbonyl group (being aldehyde, acetal, or ketone function) has been reduced to a primary or secondary hydroxyl groups.

Maltitol, also known as 4-O-α-glucopyranosyl-D-sorbitol, is industrially obtained by hydrogenation of maltose. It is of great interest due to the fact that it is more chemically stable and is containing less calories than sucrose, while advantageously possessing organoleptic properties which are very akin to those of sucrose.

Solidified sugar alcohol mixtures are mixtures of sugar alcohols that have turned from a liquid or melted state into a solidified state at room temperature (being around 20 to 25° C.). The mixture may contain crystalline material as well as amorphous material.

The solidified mixture of sugar alcohols according to the current invention is characterized in that it is containing more than 70% w/w maltitol, preferably more than 80% w/w maltitol, more preferably more than 88% w/w maltitol. The content is always expressed based upon the dry matter content of the total mixture. More specifically, the solidified mixture of sugar alcohols according to the current invention is comprising from more than 88% w/w maltitol to less than 95% w/w maltitol. In one embodiment the solidified mixture is containing more than 70% w/w, preferably more than 88% w/w maltitol and less than 94% w/w maltitol. The w/w is measured by high performance liquid chromatography.

The solidified mixture of sugar alcohols according to the current invention is comprising from 2-10% w/w mannitol based on dry matter of the mixture, preferably from 3 to 6% w/w mannitol.

Furthermore, the solidified sugar alcohol mixture containing between 70% w/w and 95% w/w maltitol, and from 2-10% w/w mannitol, preferably from 3 to 6% w/w mannitol, is further comprising from 0.1 to 5% w/w sorbitol based on dry matter of the mixture, preferably it is comprising from 0.1 to below 2% w/w sorbitol. More specifically, the solidified mixture of sugar alcohols according to the current invention is thus comprising from more than 88% w/w maltitol to less than 95% w/w maltitol, from 2-10% w/w mannitol, preferably from 3 to 6% w/w mannitol, and is further comprising from 0.1 to 5% w/w sorbitol based on dry matter of the mixture, preferably it is comprising from 0.1 to below 2% w/w. sorbitol. Beyond maltitol, mannitol and sorbitol, the dry matter of solidified mixture of sugar alcohols may contain higher polyols (=sugar alcohols with a degree of polymerisation higher than 2).

The hardness obtained upon tabletting said mixtures indicates a measure for the reaction of the mixture of sugar alcohols towards a pressure forced onto the mixture. The current solidified sugar alcohol mixture containing more than 70% w/w maltitol based on dry matter of mixture and less than 95% w/w maltitol based on dry matter of mixture and comprising from 2-10% w/w mannitol based on dry matter of the mixture, preferably from 3 to 6% w/w mannitol is having upon tabletting a fraction of said mixture having an average particle size of from 150 to 250 microns, a hardness of from 70 to 220 N, obtained at a compression force of 5 kN to 25 kN, preferably at a compression force of 10 kN, 20 kN and 25 kN.

The solidified mixture of sugar alcohols according to the current invention is further characterized in that it is having an average particle size diameter (d₅₀) of smaller than 90 microns, preferably smaller than 60 microns. The solidified mixture of sugar alcohols according to the current invention is having an average particle size diameter (d₅₀) of from 20 to 60 microns (μm). Average particle size diameters (d₅₀) of 30 μm, 40 μm or 50 μm are obtainable.

In another embodiment, the solidified mixture of sugar alcohols according to the current invention is having an average particle size diameter (d₅₀) of from 150 to 250 microns (μm).

The average particle size diameter is determined by using Laser light diffraction analyser LS 13320.

The solidified mixture of sugar alcohols according to the current invention can be further characterized by its heat of fusion, more particularly the solidified mixture of sugar alcohols according to the current invention which is having an average particle size diameter (d₅₀) smaller than 90 microns, preferably smaller than 60 μm or from 20 to 60 μm, is further characterized by its heat of fusion.

Heat of fusion, also known as enthalpy of fusion or specific melting heat, is the amount of thermal energy which must be absorbed for 1 gram of substance to change states from solid to liquid. The heat of fusion is expressed in J/g and is measured with Differential Scanning Calorimetry (DSC) while using a heating rate of 4° C./min and a start temperature of 30° C. and end temperature of 170° C. The heat of fusion of the solidified mixture of sugar alcohols according to the current invention and further having an average particle size smaller than 90 microns, is from 135 to 145 J/g. Values of 138 J/g or 143 J/g are obtainable. This solidified mixture of sugar alcohols is having, a major peak of melting temperature between 138-145° C. Values of 142° C., 143° C. or 145° C. are obtainable for these solidified sugar alcohol mixtures.

In analogy with the calculations in EP 1 738 657 the amount of amorphous maltitol can be calculated, by applying the formula:

Amount of crystalline maltitol in solidified sugar alcohol mixture (wt % on dry matter)=Measured latent heat of melting*100/latent heating of melting of pure crystalline maltitol, whereby the latent heating of melting pure crystalline maltitol (Cargill 16385) is 165.5 J/g.

The amount of amorphous maltitol (wt % on dry matter)=amount of total maltitol in solidified sugar alcohol mixture (determined with HPLC) minus (calculated amount of crystalline maltitol (see previous formula).

The solidified sugar alcohol mixture of the current invention which is further having an average particle size smaller than 90 microns, contains on dry matter from 3 to 25% amorphous maltitol, from 5 to 20%, from 5 to 15%, or values of amorphous maltitol of 5% and 7% amorphous maltitol are obtainable.

These solidified sugar alcohol mixtures have no peak of melting for crystalline mannitol and no peak for crystalline sorbitol. The total amount of amorphous sugar alcohol equals 100% minus the calculated amount of crystalline maltitol, since no other crystalline sugar alcohols were determined. The solidified sugar alcohol mixture of the current invention having an average particle size diameter (d₅₀) smaller than 90 microns, contains from 10 to 30% amorphous sugar alcohols, preferably from 12 to 25%, from 12% to 20%, or 13% to 17% based upon dry matter.

The solidified mixture of sugar alcohols according to the current invention and which is having an average particle size diameter (d₅₀) smaller than 90 microns is further characterized in that it is having a specific surface area greater than 0.40 m²/g, preferably greater than 0.45 m²/g, more preferably at least 0.50 m²/g. The specific surface area may be higher than 0.8 m²/g, from 0.8 to 1.30 m²/g. Values of 0.9, 1.1 and 1.27 m²/g are obtainable. The specific surface area is measured with BET method.

The solidified mixture of sugar alcohols according to the current invention and which is having an average particle size diameter (d₅₀) smaller than 90 microns is further characterized in that it is having an apparent (=loose) density of from 0.450-0.650 g/ml, preferably from 0.490 to 0.550 g/ml. Values of 0.490, g/ml, 0.520 g/ml or 0.540 g/ml are obtainable. The apparent density is measured by determining the weight of 250 ml of the powder in a flask of 250 ml.

In another embodiment the solidified mixture of sugar alcohols according to the current invention and which is having an average particle size diameter (d₅₀) of from 150 to 250 microns is further characterized in that it is having an apparent (=loose) density of from 0.650 to 0.750 g/ml. Values of 0.670 g/ml, 0.680 g/ml, or 0.720 g/ml are obtainable. The apparent density is measured by determining the weight of 250 ml of the powder in a flask of 250 ml.

These solidified sugar alcohol mixtures are particular suitable for the preparations of food, feed, pharma, personal care and cosmetic products, detergents, fertilizer or agrochemical products. In fact, without being limiting, the solidified sugar alcohol mixtures of the current invention can be used in food products, animal feed, health food, dietetic products, animal medicine, with bath agent, in agrochemical products, with fertilizer, with plant granules, with plant seeds or seed grains, and any other product being it ingested by humans and/or animals or any other product which can benefit from the improved properties of the solidified sugar alcohol mixtures of the current invention. The solidified sugar alcohol mixtures of the current invention can further be used as carrier for additives based on enzymes or microorganisms, detergent tablets, vitamins, flavors, perfumes, acids, sweeteners or various active ingredients with medicinal or non-medicinal applications.

Furthermore, the current invention relates to a process for preparing a solidified sugar alcohol mixture according to the current invention and said process is comprising the following steps:
a) Bringing a mixture of sugar alcohols to a moisture content of below 5%,
b) Kneading the sugar alcohol mixture through an extruder,
c) Aging the extruded solidified sugar alcohol mixture.

More specifically, the current invention describes the process for preparing a solidified sugar alcohol mixture containing maltitol characterized in that the mixture is comprising less than 95% w/w maltitol based on dry matter of mixture and upon tabletting a fraction of said mixture having an average particle size of from 150 to 250 microns, a hardness of from 70 to 220 N is obtained at a compression force of 5 kN to 25 kN and said solidified sugar alcohol mixture is containing more than 70% w/w maltitol based on dry matter of mixture and it is comprising from 2-10% w/w mannitol based on dry matter of the mixture, preferably from 3 to 6% w/w mannitol and it is comprising the following steps:
a) Bringing a mixture of sugar alcohols to a moisture content of below 5%,
b) Kneading the sugar alcohol mixture through an extruder,
c) Aging the extruded solidified sugar alcohol mixture.

The sugar alcohol, also known as polyol, or polyhydric alcohol, is a hydrogenated (reduced) form of carbohydrates wherein the carbonyl group (being aldehyde, acetal, or ketone function) has been reduced to a primary or secondary hydroxyl groups. However, the sugar alcohol of the current invention is not necessarily obtained by reduction or hydrogenation of the carbohydrate. Some of these polyols (e.g. erythritol) are obtainable via other chemical processes and/or microbial processes or fermentation.

Typically, the sugar alcohol is selected from tetritols, pentitols, hexitols, hydrogenated disaccharides, hydrogenated trisaccharides, hydrogenated tetrasaccharides, hydrogenated maltodextrins and mixtures thereof.

More specifically, the polyol may be selected from the group consisting of erythritol, threitol, arabinitol, xylitol, ribitol, allitol, altritol, gulitol, galactitol, mannitol, sorbitol, talitol, maltitol, isomaltitol, isomalt, lactitol, and mixtures thereof.

In a preferred embodiment, the polyol is selected from the group consisting of maltitol, isomalt, mannitol, sorbitol, xylitol, erythritol, higher polyols (=sugar alcohols with a degree of polymerisation higher than 2) and mixtures of one or more thereof. In more specific embodiments, the polyol is maltitol and mannitol, or maltitol, mannitol, and sorbitol or maltitol, mannitol, sorbitol and higher polyols (=sugar alcohols with a degree of polymerisation higher than 2).

More specifically, the process of the current invention is characterized in that the mixture of sugar alcohols is comprising between 70% w/w and 95% w/w maltitol. More preferably it is comprising from 2-10% w/w mannitol based on dry matter of the mixture, preferably from 3 to 6% w/w.

Furthermore, a starting sugar alcohol mixture that can be used in the process of the current invention is containing between 70%w/w and 95% w/w maltitol, and from 2-10% w/w mannitol, preferably from 3 to 6% w/w mannitol, and is further comprising from 0.1 to 5% w/w sorbitol based on dry matter of the mixture, preferably it is comprising from 0.1 to below 2% w/w sorbitol. More specifically, the mixture of sugar alcohols is thus comprising from more than 88% w/w maltitol to less than 95% w/w maltitol, from 2-10% w/w mannitol, preferably from 3 to 6% w/w mannitol, and is further comprising from 0.1 to 5% w/w sorbitol based on dry matter of the mixture, preferably it is comprising from 0.1 to below 2% w/w. sorbitol.

The sugar alcohols can be mixed in solid state or can be mixed as liquid compositions and the mixture of sugar alcohols is brought to a residual moisture content of below 5%. The liquid mixture of sugar alcohols is evaporated at a temperature of from 40° C. to 135° C., preferably from 60° C. to 135° C. Typical suitable temperatures are above 120° C. and about 130° C. The moisture content is below 5%, preferably below 4%.

After evaporation, the mixture of sugar alcohols that is having a residual moisture content of below 5%, is fed through feed lines to an extruder. The mixture is heated to a temperature from 75° C. to 135° C.

In a specific embodiment, the mixture of sugar alcohols is fed with a feed rate of 40 to 120 kg/h, preferably from 80-95 kg/h and the sugar alcohol mixture is mixed in the extruder for about 5 to 30 minutes, preferably from 10 to 20 minutes, depending upon the feed rate. Actually, the retention time is a function of the feed rate, the volume of the product in the extruder at a given time and the size of the extruder. The sugar alcohol mixture solidifies in the extruder.

An example of a suitable extruder is Readco from Readco Manufacturing Inc. The mechanistics are for instance described in U.S. Pat. No. 3,618,902. Other types of extruders may be useful and it is up to the skilled person, based upon the current disclosure, to determine the type and appropriate parameters that allow preparing the solidified sugar alcohol mixture of the current invention.

The extrudate is dropped from the extruder onto a belt and permitted to age (to cure) in the ambient temperature from 10 seconds to 15 minutes. Alternatively, the extrudate is conveyed to paddle blenders to allow time to age.

Preferably, the process is further comprising a milling step, more preferably the milling step is a jet-milling step of the aged, extruded, solidified sugar alcohol mixture. The solidified mixture of sugar alcohols according to the current invention and which is having an average particle size diameter (d₅₀) of from 150 to 250 microns can be obtained by common milling processes known in the art, while the solidified mixture of sugar alcohols according to the current invention and which is having an average particle size diameter (d₅₀) smaller than 90 microns is preferably obtainable through the process of the current invention including a jet-milling step of the aged, extruded, solidified sugar alcohol mixture.

In order to obtain a free-flowing fine powder, the solidified sugar alcohol mixture is ground in a jet-mill, a counterjet mill or classifier, suitable to grind the product to a product having an average particle size diameter below 90 microns. Suitable processes are described in WO 94/21827 and WO 2009/016133.

In addition, the current invention relates to a chewing gum composition containing a gum base, and a sweetening filler comprising a solidified sugar alcohols mixture of current invention which is having an average particle size diameter (d₅₀) smaller than 90 microns. Preferably the sweetening filler is comprising a solidified sugar alcohols mixture that is comprising between 70% w/w and 95% w/w maltitol having an average particle size diameter of smaller than 90 microns. Preferably, the chewing gum composition comprises a solidified sugar alcohol mixture having an average particle size diameter of smaller than 90 microns and which is comprising from 2-10% w/w mannitol based on dry matter of the mixture, preferably from 3 to 6% w/w and is further comprising from 0.1 to 5% w/w sorbitol based on dry matter of the mixture and preferably it is comprising from 0.1 to below 2% w/w sorbitol. More specifically, the solidified mixture of sugar alcohols according to the current invention is thus comprising from more than 88% w/w maltitol to less than 95% w/w maltitol, from 2-10% w/w mannitol, preferably from 3 to 6% w/w mannitol, and is further comprising from 0.1 to 5% w/w sorbitol based on dry matter of the mixture, preferably it is comprising from 0.1 to below 2% w/w sorbitol.

The gum base portion is retained in the mouth throughout chewing while the sweetening filler in the soluble portion dissipates with a portion of the flavour over time during chewing. The soluble portion contains additional components such as flavouring agents, colouring agents, other sweeteners, pharmaceutical agents, nutrients and the like.

The composition of the gum base typically determines whether the gum is considered as chewing gum, bubble gum or a functional gum. Preferably the gum base is inert and non-nutritive and is made from combinations of the following components: elastomers, softeners (plasticisers) emulsifiers, resins and fillers. Elastomers provide the rubbery, cohesive nature to the gums and can include for example, one or more natural rubbers, natural gums or synthetic elastomers. Resins can be used to vary the firmness of the gum base and aid in softening the elastomer component of the gum base. Softeners (also known as plasticizers) can be used to modify the ease of chewing and/or mouthfeel of the chewing gum composition. The softeners may include oils, fats, waxes and emulsifiers. Emulsifiers aid in forming uniform dispersion of the non-soluble/soluble phases and also can have plasticising properties. In addition, the chewing gum composition optionally may include adjuvants or fillers in either the gum base and/or soluble portion of the composition. Suitable adjuvants or fillers include, for example, lecithin, calcium carbonate, magnesium carbonate, magnesium silicate, ground limestone, aluminium hydroxide, aluminium silicate, talc, clay, alumina, titanium oxide and calcium phosphate. Colouring agents and whiteners can be optionally added to the chewing gum composition. Additional components of the gum base optionally can include one or more antioxidants, preservatives and/or intense sweeteners.

The flavouring agents include natural and artificial flavours and combinations thereof. The flavouring agent can be an essential oil, such as an oil derived from a plant or a fruit, peppermint oil, spearmint oil, other mint oils, clove oil, cinnamon oil, oil of wintergreen, bay, thyme, cedar leaf, nutmeg, allspice, sage, mace, almond, anise and the like. The flavouring agent may be a plant extract or a fruit essence such as apple, banana, watermelon, pear, peach, grape, strawberry, raspberry, cherry, plum, pineapple, and apricot or a combination of fruit flavourings (e.g. Tutti frutti). Furthermore, the flavouring agent can be a citrus flavour, such as extract, essence or oil of lemon, lime, orange, tangerine, grapefruit, or kumquat. These flavouring agents may be used in liquid or solid form and may be used individually or in admixture.

The intense sweeteners may include, but are not limited to, sucralose, aspartame, salts of acesulfame (e.g. acesulfame-K), alitame, saccharin and its salts, cyclamic acids and its salts, glycyrrhizin, dihydrochalcones (e.g. neohesperidin dihydrochalcone) thaumatin, monellin, neotame, stevioside, mogroside, phyllodulcin, mabinlin, brazzein, pentadin, and the like, alone or in combination.

Other sweeteners may be present such as tagatose, other sugar alcohols, trehalose, isomaltulose and the like, alone or in combination.

Chewing gum compositions can be prepared using known techniques. In general, chewing can be manufactured by sequentially adding the various chewing gum ingredients to any commercial available mixer known in the art, see for example U.S. Pat. No. 5,334,397. After the ingredients (including the solidified sugar alcohol mixture according to the current invention) have been thoroughly mixed, the gum mass can be discharged from the mixer and shaped into the desired forms such as by rolling into sheets and cutting to sticks, extruding into chunks, or casting into pellets or tablets. A variety of chewing gum and bubble gum shapes are possible, including sticks, chunks, tablets, centre filled, balls, fruit shapes, cigarette shaped, coins, tube gums and compressed powder gums.

The chewing gum prepared with the solidified sugar alcohol mixture of current invention allowed to obtain chewing gums with a hardness in the range of 2900 to 6000 g (measured after 1 month storage at 20° C. at 40% relative humidity) and the thus obtained chewing gum each have a higher hardness than the hardness of the chewing gum based upon milled crystalline maltitol or the corresponding milled physical blends. For the milled crystalline maltitol or the corresponding milled physical blends the granulometry was comparable with the granulometry of the products of the current invention.

Furthermore, the current invention relates to a tablet comprising tablet ingredients and the solidified sugar alcohol according to the current invention and which is having an average particle size diameter (d₅₀) of from 150 to 250 microns. In particular, it relates to the tablet comprising a solidified mixture of sugar alcohols which is having an average particle size diameter (d₅₀) of from 150 to 250 microns and that is comprising between 70% w/w and 95% w/w maltitol having a hardness of from 70 N to 220 N at a compression force of 5 kN to 25 kN, preferably at a compression force of 10 kN, 20 kN and 25 kN.

Preferably, the tablet is comprising a solidified mixture of sugar alcohol which is having an average particle size diameter (d₅₀) of from 150 to 250 microns and which in itself is comprising from 2-10% w/w mannitol based on dry matter of the mixture, preferably from 3 to 6% w/w and is further comprising from 0.1 to 5% w/w sorbitol based on dry matter of the mixture. Furthermore, it relates to the tablet containing the solidified sugar alcohol mixture which is having an average particle size diameter (d₅₀) of from 150 to 250 microns and is containing between 70% w/w and 95% w/w maltitol, and from 2-10% w/w mannitol, preferably from 3 to 6% w/w mannitol, and is further comprising from 0.1 to 5% w/w sorbitol based on dry matter of the mixture. More specifically, the tablet is based upon the solidified mixture of sugar alcohols according to the current invention which is having an average particle size diameter (d₅₀) of from 150 to 250 microns and which is comprising from more than 88% w/w maltitol to less than 95% w/w maltitol, from 2-10% w/w mannitol, preferably from 3 to 6% w/w mannitol, and is further comprising from 0.1 to 5% w/w sorbitol based on dry matter of the mixture, preferably it is comprising from 0.1 to below 2% w/w. sorbitol.

The term “tablet”, as used herein, includes any tablet, in particular tablets in any form, shape and of any physical, chemical or sensory property, and tablets for any route of administration, indication and application.

Additives or auxiliary substances such as lubricants can be added and may include sweeteners, flavorings, taste substances and coloring agents, food-compatible acids, disintegrants, monosaccharides, disaccharides, sugar alcohols, starch, starch derivatives, pectins, polyvinylpyrrolidone, cellulose, cellulose derivatives, intense sweeteners, stearic acid or the salts thereof, or inulin. Preferably, as a lubricant agent in tablet formation, magnesium stearate, calcium stearate, stearic acid, sucrose fatty acid esters, and/or talc and the like can be added according to needs. Furthermore surface active agents such as sodium lauryl sulfate, propylene glycol, sodium dodecanesulfonate, sodium oleate sulfonate, and sodium laurate mixed with stearates and talc, sodium stearyl fumarate, sucrose fatty acid esters, and the like can be added according to needs.

When tablets are prepared for pharmaceutical applications an active ingredient such as a drug is added, and fillers, lubricating agents or disintegrating agents are added if needed.

Finally, the current invention relates to a process for preparing these tablets. Said process for preparing the tablet according to the current invention, comprises the following steps:
a) Optionally granulating the solidified sugar alcohol mixture prepared according to the current invention,
b) Blending with a lubricant,
c) Tabletting at compressing forces from 5 to 25 kN.

The process for preparing the tablets of the current invention can be very simple, by blending a lubricant with the solidified sugar alcohol mixture which is having an average particle size diameter (d₅₀) of from 150 to 250 microns followed by tabletting at compression forces from 5 to 25 kN.

Eventually solidified sugar alcohol mixture which is having an average particle size diameter (d₅₀) smaller than 90 microns can be granulated, followed by blending with lubricant and tabletting at compressing forces from 5 to 25 kN.

Granulation methods can be divided in two basic types, namely wet methods, which use a liquid in the process, and dry methods in which no liquid is used. Wet granulation is most often used and involves many steps, including: agglomerating (granulating) of dry primary powder particles of active ingredients and excipients in the presence of a granulating fluid upon agitation using low-shear or high-shear mixers or fluidized beds, wet sieving (wet screening) to remove larger lumps, drying the granulated product, and milling or sieving (screening) the dried granulated product to achieve a granulated product having the desired granule size distribution. The obtained granulation may subsequently be tabletted.

The invention will hereunder be illustrated in the form of the following examples.

### EXAMPLES

### Example 1

Equipment:
Extruder: Readco, 5 Inch
Fluid bed dryer, Retsch TG 200
Cutting mill, Hosokawa Alpine R 0 20/12
Sieving apparatus: Allgaier, Tumbler screening maschine TSM 600/3
Micronette M100 jet mill of Nuova Guseo S.r.I.
Buss evaporator
Average (Median) particle size measurement: Laser light diffraction analyser LS 13320
Dry substance: Karl Fischer Titrator, Mettler Toledo DL38

Evaporation Temperature 120° C., app. 5% d.s. mannitol Addition, use of a Dryer:

In a stirred 1250 L reactor, 700 kg of liquid C*Maltidex H 16330 (Cargill) (71.6% d.s.) was filled. The solution was stirred and the temperature was kept at 55° C. by heating. 25.05 kg of solid C*PharmMannidex 16701 (Cargill) (99.9% d.s.) were added. The mixture was stirred overnight at 55° C. resulting in a homogenous liquid solution. Afterwards it was evaporated at 120° C. at reduced pressure. After evaporation the material had a dry substance of 95.6% d.s. For extrusion the viscous solution was pumped on a Readco Extruder (95 kg/h, kneading time 20 min). After extrusion white, crystalline ropes of solidified material were obtained which were cooled on a cooling belt. A dry substance of 96.7% was determined. The material was sifted and the fraction <900 μm and dried on a fluid bed dryer. The dried product was brought on the jet-mill (Micronette M100 jet mill of Nuova Guseo S. r. I), having a nitrogen gas pressure in venture and micro-chamber of 5 bar, a screw rate of 24 rpm and a feed rate of 2.6 kg/h. Fine powdery material (product: example 1a) was obtained, having a dry substance of 99.5% and an average (median) granulometry size (d50) of 39.4 μm, (measured by Laser light diffraction analyser LS 1332).

Product: example 1a (granulometry size (d50) of 39.4 μm):
The solidified sugar alcohol contained 91.32% maltitol, 5.15% mannitol, 1.26% sorbitol and 2.27% higher polyols, according to HPLC analysis.
The heat of fusion is 142.7 J/g and it has a major peak of melting temperature at 143.1° C. (measure by DSC on dried (with phosphor pentoxide) material using a heating rate of 4° C./min and a start temperature of 30° C. and end temperature of 170° C.)
The specific surface area measured with BET method is 1.06 m²/g.
The apparent (loose) density is 0.490 g/ml.

The other fraction >900 μm was dried and milled and a coarse fraction (product: example 1b) was obtained with an average granulometry size (d50) of 178 μm, (measured by Laser light diffraction analyser LS 1332).

The solidified sugar alcohol contained 91.32% maltitol, 5.15% mannitol, 1.26% sorbitol and 2.27% higher polyols, according to HPLC analysis.

The apparent (loose) density of product example 1 b is 0.670 g/ml.

### Example 2

Equipment:
See example 1—no fluid bed dryer.

Evaporation Temperature 130° C., app. 5% d.s. Mannitol Addition:

In a stirred 1250 L reactor 700 kg of liquid C*Maltidex H 16330 (Cargill) (71.6% d.s.) was filled. The solution was stirred and the temperature was kept at 55° C. by heating. 25.05 kg of solid C*PharmMannidex 16701(Cargill) (99.9% d.s.) were added. The mixture was blended overnight at 55° C. resulting in a homogenous liquid solution. Afterwards it was evaporated at 130° C. at reduced pressure. After evaporation the material had a dry substance of 98.7% d.s. For extrusion the viscous solution was pumped on a Readco Extruder (113 kg/h, kneading time 20 min). After extrusion white crystalline ropes of solidified material were obtained which were cooled on a cooling belt. The cooled material was crushed on a cutting mill. The material was sifted and the fraction <900 μm was jet milled. The product was brought on the jet-mill (Micronette M100 jet mill of Nuova Guseo S. r. I), having a nitrogen gas pressure in venture and micro-chamber of 5.3 bar, a screw rate of 18 rpm and a feed rate of 2.2 kg/h. Fine powdery material (product: example 2a) was obtained having a dry substance of 99.5% and an average (median) granulometry size (d50) of 29.7 μm, (measured by Laser light diffraction analyser LS 1332).

Product: example 2a (granulometry size (d50) of 29.7μm):
The solidified sugar alcohol contained 91.32% maltitol, 5.12% mannitol, 1.27% sorbitol and 2.29% higher polyols, according to HPLC analysis.
The heat of fusion is 138.4 J/g and it has a major peak of melting temperature at 142.3° C. (measure on dried (with phosphor pentoxide) material using a heating rate of 4° C./min and a start temperature of 30° C. and end temperature of 170° C.)
The specific surface area measured with BET method is 1.27 m²/g.
The apparent (loose) density is 0.516 g/ml.

The other fraction >900 μm was dried and milled and a coarse fraction (product: example 2b) was obtained with an average granulometry size (d50) of 234 μm, (measured by Laser light diffraction analyser LS 1332). The solidified sugar alcohol contained 91.32% maltitol, 5.12% mannitol, 1.27% sorbitol and 2.29% higher polyols, according to HPLC analysis. The apparent (loose) density of product example 2b is 0.720 g/ml.

### Example 3

Equipment:
See example 1—no fluid bed dryer

Evaporation Temperature 130° C., app. d.s. 3,5% Mannitol Addition:

In a stirred 1250 L reactor 700 kg of liquid C*Maltidex H 16330 (Cargill) (71.6% d.s.) was filled. The solution was stirred and the temperature was kept at 55° C. by heating. 17.5 kg of solid C*PharmMannidex 16701 (Cargill) (99.9% d.s.) were added. The mixture was stirred overnight at 55° C. resulting in a homogenous liquid solution. Afterwards it was evaporated at 130° C. at reduced pressure. After evaporation the material had a dry substance of 98.2% d.s. For extrusion the viscous solution was pumped on a Readco Extruder (96 kg/h, kneading time 20 min). After extrusion white crystalline ropes of solidified material were obtained which were cooled on a cooling belt. The cooled material was crushed on a cutting mill. The material was sifted and the fraction <900 μm was jet milled. The product was brought on the jet-mill (Micronette M100 jet mill of Nuova Guseo S. r. I), having a nitrogen gas pressure in venture and micro-chamber of 5 bar, a screw rate of 20 rpm and a feed rate of 2.2 kg/h. Fine powdery material (product: example 3a) was obtained, having a dry substance of 99.4%. and an average (median) granulometry size (d50) of 49.0 μm, (measured by Laser light diffraction analyser LS 1332).

Product: example 2a (granulometry size (d50) of 49.0 μm):
The solidified sugar alcohol contained 93.82% maltitol, 3.52% mannitol, 0.86% sorbitol and 1.79% higher polyols, according to HPLC analysis.
The specific surface area measured with BET method is 0.92 m2/g.
The apparent (loose) density is 0.539 g/ml.

The other fraction >900 μm was dried and milled and a coarse fraction (product: example) 3b) was obtained with an average granulometry size (d50) of 155 μm, (measured by Laser light diffraction analyser LS 1332). The solidified sugar alcohol contained 93.82% maltitol, 3.52% mannitol, 0.86% sorbitol and 1.79% higher polyols, according to HPLC analysis. The apparent (loose) density of product example 3b is 0.680 g/ml.

### Example 4

Chewing Gum Preparation

Recipe:

| | CB |
|---|---|
| Ingredients | (%)¹ |
| Gum Base - Cafosa gum base | 35 |
| Sweetener - solidified sugar alcohol | 53 |
| mixture - example fraction a (fine product) | |
| Maltitol syrup 16303L (Cargill) | 10.0 |
| Glycerin | 2.0 |
| Total | 100 |

¹CB % is commercial basis”, refers to the compounds in the recipe that are used ‘as is’ and used in the state they are commercially available. The sweetener is added at the dry substance that is obtained in the process described before.

Procedure

The chewing gum was made by preheating a Z-blade apparatus (Winkworth Model MZ 4/2) to 50° C. The gum base (Cafosa Gum, S. A. U., Barcelona, Spain) was heated in a microwave for 3 to 5 minutes and then placed in the Z-blade and mixed at speed 4 (=about 22 rpm) in a forward direction for 5 minutes. Half of the sweetener composition was added to the gum base in the Z-blade and mixed for 5 minutes at speed 4. The remaining sweetener was then added in the blender and mixed for further 5 minutes. The maltitol syrup was added and mixed again for 5 minutes. Glycerin was then added and mixed for 5 minutes. Liquid flavor was lastly added and the entire content in the blender was mixed not more than 3 to 5 minutes.

The chewing gum has been tested for their hardness while stored in a cabinet (25° C.-40% Relative Humidity). The gum is completely sealed in plastic), and compared with chewing gum prepared from crystalline maltitol or a regular physical blend of maltitol and mannitol.

| | Hardness measurements (g). Storage | | |
|---|---|---|---|
| | conditions: Room Temperature (20° C.) | | |
| | 1 day - | A week - | |
| | Cabinet | Cabinet | A month - |
| | Storage | Storage | cabinet |
| Samples - chewing gum | Average | Average | Storage |
| containing materials from | Hard. | Hard. | Average Hard. |
| Example 1a (fine | 3802 | 4481 | 3669 |
| product) | | | |
| Example 2a (fine | 5705 | 6660 | 5915 |
| product) | | | |
| Example 3a (fine | 3462 | 4009 | 2985 |
| product) | | | |
| Milled Crystalline | 1794 | 3048 | 2586 |
| Maltitol (CH | | | |
| 16385 - Cargill | | | |
| Milled Physical | 1830 | 2884 | 2466 |
| Blend maltitol | | | |
| mannitol as in | | | |
| example 1 or 2 | | | |
| Milled Physical | 1772 | 2883 | 2135 |
| Blend maltitol and | | | |
| mannitol as in | | | |
| example 3 | | | |

For the milled crystalline maltitol or the corresponding milled physical blends the granulometry was comparable with the granulometry of the products of the current invention.

The chewing gum prepared with the fine products of solidified sugar alcohol mixture of example 1 a to 3a allowed to obtain chewing gums with a hardness in a range of 2900 to 6000 g (measured after 1 month storage at 20° C. at 40% relative humidity) and the thus obtained chewing gum each had a higher hardness than the hardness of the chewing gum based upon milled crystalline maltitol or the corresponding milled blends.

### Example 5

Tablet Formation

Recipe and Procedure:

99% solidified sugar alcohol mixture (coarse materials (samples b) obtained in examples)+1% Magnesium Stearate

Blending for 3 minutes

Tabletting equipment: Fette 1200i at compression force from 5 to 25 kN.

The hardness (in Newton, N) was measured after three days and the results are shown in the following table

TABLE

| Sample containing | | | | | |
|---|---|---|---|---|---|
| products from: | 5 KN | 10 KN | 15 KN | 20 KN | 25 KN |
| Example 1b | 93 | 190 | 233 | 204 | 200 |
| Example 2b | 50 | 154 | 199 | 203 | 197 |
| Example 3b | 85 | 157 | 180 | 216 | 199 |
| Crystalline maltitol Cargill | 15 | 26 | 36 | 14 | — |
| (C*Maltidex CH 16385) | | | | | |

Tablets could be prepared with the solidified mixtures of the current invention.

1.-11. (canceled)

12. A solidified sugar alcohol mixture containing maltitol, wherein the mixture comprises more than 70% w/w and less than 95% w/w maltitol based on dry matter of mixture and from 2 to 10% w/w mannitol based on dry matter of the mixture, and upon tabletting a fraction of the mixture having an average particle size of from 150 to 250 microns, a hardness of from 70 N to 220 N is obtained at a compression force of 5 kN to 25 kN.

13. The mixture of claim 12, wherein the mixture comprises from 3 to 6% w/w mannitol based on dry matter of the mixture.

14. The mixture of claim 12, wherein the mixture has an average particle size diameter of smaller than 90 microns.

15. The mixture of claim 12, wherein the mixture has a specific surface area greater than 0.40 m²/g.

16. The mixture of claim 12, wherein the mixture has an apparent density of from 0.45 to 0.65 g/ml.

17. The mixture of claim 12, wherein the mixture has a heat of fusion of 135 to 145 J/g.

18. The mixture of claim 12, wherein the mixture has an average particle size diameter of from 150 to 250 microns.

19. The mixture of claim 18, wherein the mixture has an apparent density of from 0.65 to 0.75 g/ml.

20. A process for preparing the solidified sugar alcohol mixture of claim 1, the process comprising:
a) bringing a mixture of sugar alcohols to a moisture content of below 5%;
b) kneading the sugar alcohol mixture through an extruder; and
c) aging the extruded solidified sugar alcohol mixture.

21. The process of claim 20, wherein the process further comprises jet-milling of the aged, extruded solidified sugar alcohol mixture.

22. A chewing gum composition containing a gum base, a flavoring agent, and a sweetening filler comprising the solidified mixture of claim 12.

23. A chewing gum composition containing a gum base, a flavoring agent, and a sweetening filler comprising the solidified mixture of claim 18.

24. A tablet comprising tablet ingredients and the solidified mixture of claim 12.

25. A tablet comprising tablet ingredients and the solidified mixture of claim 18.
